(19) United States
(12) Patent Application Publication
(10) Pub. No.: US 2012/0073896 A1
(43) Pub. Date: Mar. 29, 2012

(54) VEHICLE HAVING ARTICULATED STEERING, IN PARTICULAR ARMORED VEHICLE

(76) Inventor: Gerhard Skoff, Wien (AT)

(21) Appl. No.: 13/245,321

(22) Filed: Sep. 26, 2011

Related U.S. Application Data
(63) Continuation-in-part of application No. PCT/EP2010/001735, filed on Mar. 29, 2010.

(30) Foreign Application Priority Data
Mar. 26, 2009 (DE) 10 2009 014 401.3

(51) Int. Cl. B62D 13/00; F41H 7/02

(52) U.S. Cl. 180/400; 89/36.08

(57) ABSTRACT

A vehicle is provided wherein, between an unmanned front drive module (2) and a manned mission module (3), an articulated steering drive (4) is provided, so that the entire vehicle (1) is driven from the mission module (3) via the drive module (2). More specifically, the vehicle, such as an armored vehicle, is divided into an anterior drive module and a posterior mission module, wherein the mission module is configured to accept a vehicle crew comprising a driver, and the mission module comprises one or more mission-specific expansions, and wherein the drive module comprises a drive motor and is unmanned, and the vehicle further comprises an articulated steering drive integrated between the drive module and the mission module so the drive module is steered by the driver in the mission module and so that the vehicle is thus moved by tracking the mission module behind the drive module.

This is a Continuation-in-Part application in the United States of International Patent Application No. PCT/EP2010/001735 filed Mar. 19, 2010, which claims priority on German Patent Application No. DE 10 2009 014 401.3, filed Mar. 26, 2009. The entire disclosures of the above patent applications are hereby incorporated by reference.

### FIELD OF THE INVENTION

The invention relates to a vehicle having articulated steering, preferably for transport of a vehicle crew.

### BACKGROUND OF THE INVENTION

In order to design also larger vehicles with better steering and handling ability, or in order to provide the same with higher modularity, vehicles are frequently subdivided. Known, among others, is the armored all-terrain transport-vehicle BV 206 made by the Hägglund Company (see for example http://www.deutschesheer.de/portal/a/heer/kcxml/04_Sj9SPykssyOxPLMnMzOvMOY QjzKLNzSLt3COAMmZxbvHM7mb60eCGOYmRhAxkLyBMOgQqjloJVXflyM N1XfWz9AvyA3NKLcOVERAHsLzog!/delta/base64xml/L2dJQSEvUUt3QS8OS VVFLzZfMTZfOEFC?yw contentURL=%2FC1256F870054206E %2FW269WBR6361INFODE %2Fcontent.jsp or http://www.google.de/imgres?imgurl=http://www.panzerbaer.de/helper/pix/bw_bv_{—206} d-1906.jpg&imgrefurl=http://www.panzerbaer.de/helper/bw_trspfz_bv206d-a.htm&h=332&w=650&sz=115&tbnid=X4uFmZPhzhhG6M::&tbnh=70&tbnw=137&pr ev=/images %3Fq %3Dh %25C3%25A4gglund&hl=de&usg=6XY17d4oCj8iQKnFcYzFQ 8fylY=&ei=8r6aSfLtNsam-gaf4LizCA&sa=X&oi=image result&resnum=4&ct=image&cd=1).

In this case of a subdivided vehicle, the anterior vehicle pulls a posterior vehicle or a posterior vehicle part of equal construction height. In the anterior vehicles, which are provided with drive, are located, in addition to the driver and the front seat passenger, other persons who are to be transported. Persons can also be transported in the posterior vehicle part of the subdivided vehicle.

It is the object of the present invention to propose a novel concept for vehicles of this type, which are preferably armored and which guaranty adequate steering and handling capability.

### SUMMARY OF THE INVENTION

The means for attaining the object of the invention is provided by the characteristics of a first embodiment, which pertains to a vehicle (1), in particular armored vehicles, divided into a drive module (2) and a mission module (3) having: (a) the mission module (3) serving for accepting a vehicle crew of at least one driver as well as mission-specific expansions, (b) the drive module (2) carrying at least one drive motor and being unmanned, and (c) an articulated steering drive (4) that is integrated between the drive module (2) and the mission module (3) in such manner that the drive module (2) is steered by the driver in the mission module (3) and the vehicle (1) is thus moved by tracking the mission module (3). Various other beneficial embodiments of the invention are listed below.

In accordance with a second embodiment of the present invention, the first embodiment is modified so that the articulated steering drive (4) also drives the posterior mission module. In accordance with a third embodiment of the present invention, the first embodiment or the second embodiment are further modified so that the articulated steering unit (4) is attached at the anterior housing part (20) of the mission module (3) and at the posterior housing part of the drive module (2). In accordance with a fourth embodiment of the present invention, the first embodiment or the second embodiment are further modified so that only the mission module (3) has to have a high degree of protection, for which purpose armor-plating (100) is arranged only around the mission module (3).

In accordance with a fifth embodiment of the present invention, the first embodiment, the second embodiment, the third embodiment and the fourth embodiment are further modified so that the drive module (2) has a low construction mode or profile relative to the mission module (3), so that the driver can operate the drive module (2) by looking over and above the drive module (2). In accordance with a sixth embodiment of the present invention, the first embodiment, the second embodiment, the third embodiment, the fourth embodiment, and the fifth embodiment, are further modified so that heat insulating means (200) against its own IR-signature are arranged around the drive module (2). In accordance with a seventh embodiment of the present invention, the first embodiment, the second embodiment, the third embodiment, the fourth embodiment, the fifth embodiment, and the sixth embodiment, are further modified so that the mission module (3) is equipped with an angle mirror/periscope (11) on the roof (21) by means of which the driver and/or the Commander can steer the drive module (2), by looking over the same. In accordance with an eighth embodiment of the present invention, the first embodiment, the second embodiment, the third embodiment, the fourth embodiment, the fifth embodiment, the sixth embodiment, and the seventh embodiment, are further modified so that that cameras (53) are integrated for steering at the drive module (2) and/or the mission module (3). In accordance with a ninth embodiment of the present invention, the first embodiment, the second embodiment, the third embodiment, the fourth embodiment, the fifth embodiment, the sixth embodiment, the seventh embodiment, and the eighth embodiment, are further modified so that for energy supply of the mission module (3), energy lines (86) are arranged from the drive module (2) to the mission module (3) and/or the mission module (3) disposes of its own supply (82) of energy.

The present invention is based on the idea of dividing a vehicle into an anterior drive module and a posterior mission module, which are both connected with each other by articulated steering, or by an articulated steering drive, in such manner that the anterior module is steered by the posterior module, wherein the posterior module holds at least one driver, and wherein the anterior module drives and moves the posterior module by means of the articulated steering drive.

It is possible to ascertain the tendency from DE 10 2004 026 237 A1 of providing the drives of the vehicle in a separate front- and rear component, separated from a main component. This is done for greater vehicle protection against the effect of a land mine Steering is done in the conventional manner, which does not employ articulated steering.

A vehicle with articulated steering is known from DE 101 00 775 A1, which contains two chassis components arranged behind each other in a longitudinal vehicle direction, to which is attached, on the one side, a front axle, and on the other side, a rear axle. Both chassis components are in contact with each other via an essentially vertically aligned articulated axle in such manner that they can be swiveled relative to each other using a steering device, thus permitting vehicle steering.

A vehicle with articulated steering is disclosed in AT-PS 332-231, in which the anterior chassis component is connected with the posterior chassis component via a dual articulated joint. In the steering linkage between the dual articulated joint and the anterior chassis component on the one side and the posterior chassis component on the other side is, respectively arranged, a hydraulically operable lifting aggregate, etc.

DD 219 003 A3 describes a steering linkage for vehicles with articulated steering. In order to achieve improved steering behavior, it is proposed that the steering rod be arranged displaceably on one vehicle component, so that a steering movement causes the actuation of the servomotors for mutual articulation of the vehicle components.

A vehicle with articulated steering, in particular wheel loaders, is also known from DE 20 2006 015 828 U1. In this case, a front carriage and a rear carriage are joined together by means of a fixed spherical bearing.

A description of steering an unmanned vehicle by means of an electronic tow-bar from a constructively de-coupled vehicle, located in the rear, is given in DE 10 2004 003 055 A1.

As already mentioned, the present suggestion is different from the aforementioned vehicles. The present invention integrates an articulated steering drive between a fully self-contained drive module, which contains only the drive, and a mission module, which carries only the crew, with the steering of the (unmanned) front drive module taking place from the (manned) rear mission module via the articulated steering or articulated steering drive. The drive module itself drives both the drive module as well as the mission module via the articulated steering device. For energy supply of the mission module, lines can be arranged from the drive module to the mission module. Alternatively, one can also additionally install an independent power supply in the mission module, for example, via an auxiliary drive of the gearbox elements driven by the articulated steering drive. The articulated steering drive thus connects both vehicle modules to form one vehicle entity (i.e., one vehicle assembly).

The resulting benefit obtained from these features is that only the mission module needs to have a high degree of protection, i.e. it must be totally armored. The mission module itself, which carries the crew (driver, front seat passenger/commander), has a small IR signature, since it does not have a motor.

Another benefit of the present invention is the potentially low construction mode or profile of the drive module, since no persons need to be carried therein and only the drive aggregate and the pertinent drive elements need to be stored in the drive module. Moreover, the drive module needs only to be equipped with heat insulating means against its own IR-signature, for example, instead of the required armor-plating for people. Given the circumstance that the drive module is only required to carry the drive and no longer some of the crew, the modularity of the drive is expanded to other mission modules as well (for example, as a drive for a corresponding medical first aid module). Aside from greater flexibility and availability due to the readily exchangeable mission modules, the unmanned drive module can additionally serve as a mine triggering unit, since the rear module accurately tracks the front module. As a result, all types of currently known anti-tank mines are triggered by the unmanned drive module, and the mission module, which carries the crew, is thus fully protected against all types of mine threats.

With modern chain vehicles, steering is done by means of hydrostatic overlay gearing mechanism, which assigns a different drive speed to the left and the right chain, thus facilitating a steering movement. The drawback of such a design lay-out is that the major portion of the drive energy is consumed by the hydrostatic overlay gearing and is not available for forward drive. In the embodiment presented here, in accordance with the present invention, the steering movement takes place by articulation of the drive module from the mission module by means of the articulated steering drive, and not by different drive speeds on the right and the left side of the drive. Consequently, full engine output is available for driving, even for executing turning maneuvers.

Both modules (i.e., the drive module and the mission module) can, in accordance with the present invention, be equipped either with wheels or with chains or with a combination of front chains, for example, and rear wheels. Chain drive, however, is preferably presented here.

The anterior drive module is unmanned, has a low profile and comprises a motor, preferably an automatic gear-box, a cooling system, transfer gear, differential and the articulated steering drive. Because the anterior drive module has a very low profile and, thus, presents a smaller signature, the likelihood of being hit in case of hostile attack is lower, due to its small silhouette.

The posterior mission module comprises the driver, and the commander, as well as the fixtures of the mission module(s) proper. This configuration also results in the mission module not being affected by motor noise and motor vibration. Since, due to the division of the vehicle and the reduction in total weight of the entire vehicle (drive module constructed smaller and has no or has less armor-plating than the mission module), it is possible to employ rubber chains as chain drives, which also minimizes vibration due to chain excitation. In particular, maintenance and repair are made less complicated, because easier accessibility to the drive module and, thereby, to its components, is made possible. The employment of ABS-brakes can now, likewise, be realized.

The present mobility concept permits optimally protected operations in regions that are inaccessible for other vehicles; the vehicle of the present invention is lighter and has a high degree of protection, and it is structurally smaller in size than comparable known systems or concepts, and it possesses unlimited roadworthiness.

### BRIEF DESCRIPTION OF THE DRAWINGS

The invention, and thus the concept, shall be explained in more detail using an exemplary embodiment illustrated by the following drawings.

FIG. 1 depicts a vehicle with its chain drive separated into two modules.

FIG. 2 depicts a vehicle with its wheel drive separated into two modules.

FIG. 3 is a schematic illustration of a vehicle embodiment in accordance with the present invention corresponding to that of FIG. 1, although with additional details shown.

### DETAILED DESCRIPTION OF THE INVENTION

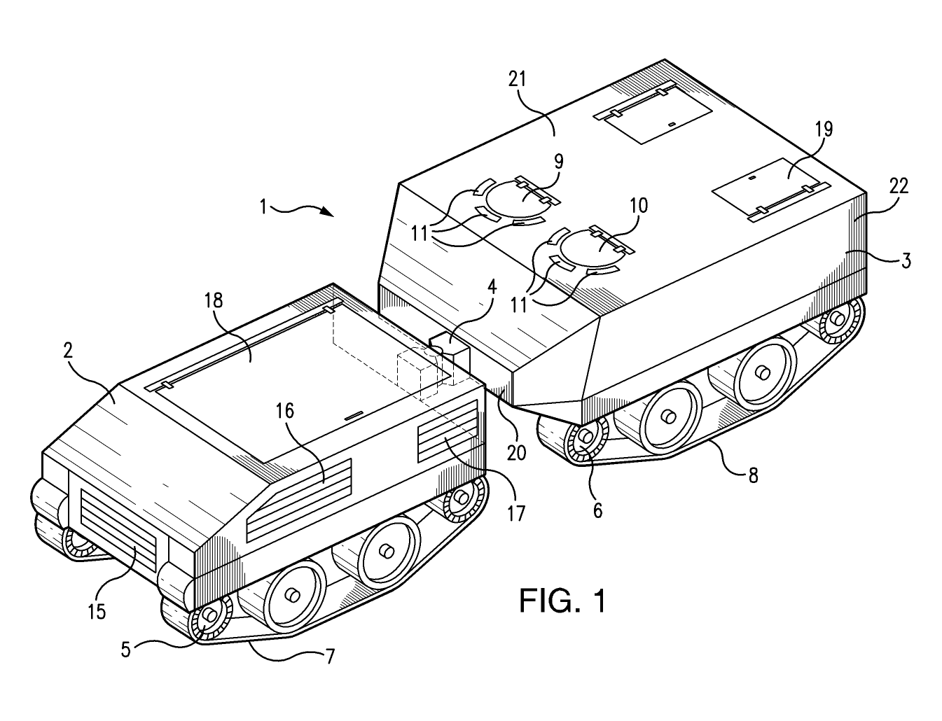

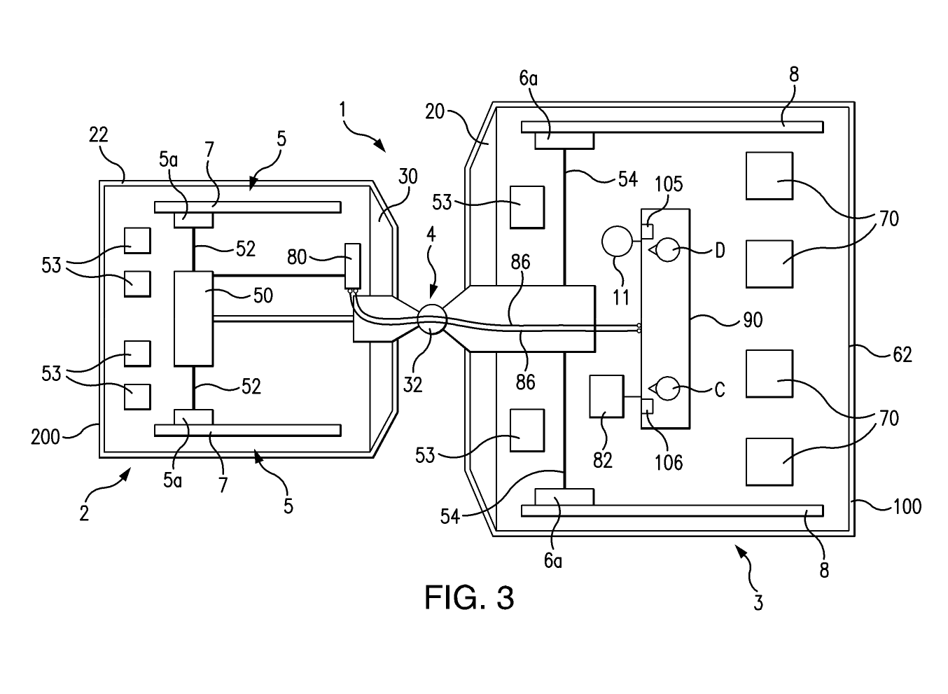

FIG. 1 represents a vehicle 1, according to the present invention, which is separated into a drive module 2 and a mission module 3. The drive module 2 and the mission module 3 are joined by means of a conventional (and therefore not shown in more detail) articulated steering drive 4. Steering takes place via the articulated steering drive 4 and, if needed, also a supply of energy for the mission module 3 may be provided via a plurality of energy lines (i.e., cables 86 in FIG. 3). However, a separate energy supply 82 may also only be integrated in the mission module 3, as well as the drive of the mission module 3. To that end, the articulated steering drive 4 is integrated at the anterior housing part 20 of the mission module 3 and the posterior housing part 30 of the drive module 2.

Both modules 2, 3 have their own chain-drives 5, 6, respectively, with the chain 7 of the anterior drive module 2 being moved via chain-wheels 5a and drive-track (not shown in more detail than by 52 in FIG. 3) of a drive motor (not shown in more detail than by 50 in FIG. 3), and the chains 8 of the posterior module 3 are moved by the chain wheels 6a via the articulated steering drive 4 and drive-track (not shown in more detail than by 54 in FIG. 3) by the drive 50 of the drive module 2.

The mission modules 3 are differently designed, depending upon their mission. In each case, driver D and/or commander C is/are seated in front in a crew compartment 90. They have visibility in front and on the sides for steering of vehicle 1, through periscope 11, looking through hatches 9, 10, or from under armored protection 100. The drive module 2 is operated and steered, as a rule, by the driver D via controls 105 operably connected to the articulated joint 32. Provision is likewise made for the possibility of steering by the Commander C (front seat passenger), who may steer using an additional set of controls 106 that are operably connected to the articulated joint 32 of the articulated steering drive 4.

As an alternative, integration of cameras 53 in the drive module 2, with attachment at the mission module 3, is considered as sufficient for additional steering visibility, because the drive module 2 is lower than the mission module 3 in profile, so that the driver D as well as the commander C, seated under hatches 9 and 10, respectively, and who are looking over and above drive module 2, are able to safely ascertain the path to be taken (i.e., are able to ascertain the direction in which to steer the drive module 2).

The mission equipment (not shown in more detail than by the mission-specific expansions 70 in FIG. 3) is located behind the driver D and the Commander C, for example, and may include the seats for transporting additional crew. In addition, a weapons station (not shown here in more detail) may be located on the vehicle roof 21, and may be protected by hatch cover 19. Alternative possibilities are the design of the mission module additionally as a medical aid vehicle, as a radio communication vehicle or an observation vehicle, as an Atomic-Biological-Chemical (ABC) vehicle with an ABC mission, or as a weapons carrier with highly diversified weaponry, for example, a remote controlled gun carriage for light and medium machine guns, or for a mortar etc., and such other functions as are known according to the state of the art.

The casing 22 of the drive module 2 and the casing 62 of the mission module 3 can consist of bullet-proof protective materials, for example, reinforced steel or similarly acting composite materials according to the state of the art. The degree of protection may differ depending upon the planned mission for the different mission modules 3. Different mission modules 3 depend upon the number and kinds of mission-specific expansions 70, such as discussed above, which depend upon whether the mission module 3 has medical mission so that the expansions 70 may include medical equipment, or an observation mission so that the expansions 70 may include observation equipment, or a communication mission so that the expansions 70 may include communications equipment, or an ABC mission so that the expansions 70 may include ABC equipment, or a combat mission so that the expansions 70 may include additional weapons systems.

Drive module 2 can have several openings 15, 16, 17, in order to provide combustion air for the motor 50 and to supply the corresponding cooling air volume for cooling the motor 50. Access to the motor space, in which the motor 50 is disposed, can be facilitated through a hatch cover 18.

In another embodiment of the invention, the mission module 3 is only pulled by the drive module 2 and is only steered via the articulated steering unit 4, which, in this case, is not designed as a drive.

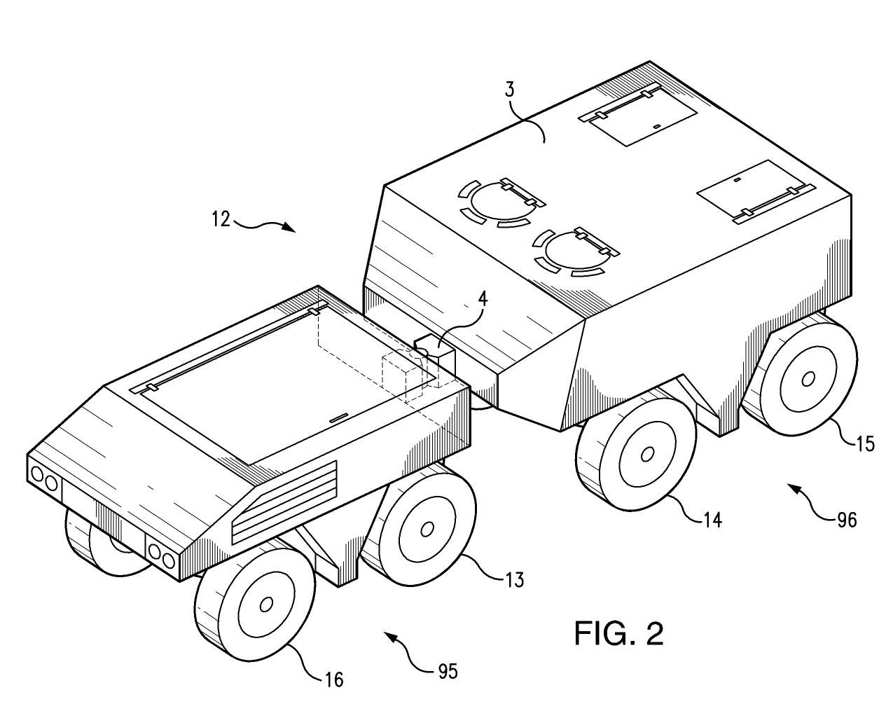

FIG. 2 depicts an alternative embodiment vehicle 12 to the vehicle 1 represented in FIG. 1. In this alternative embodiment, the chain drives 5, 6 of the embodiment of FIG. 1 have been replaced by respective wheel drives 95, 96, with an otherwise identical embodiment configuration employed. Each of the axles 13, 14, 15, 16 of the respective wheel drives 95, 96 can be independently propelled, but that is not a requirement of the embodiment. Thus, the drive of the embodiment of FIG. 2 may include more than one drive motor. For example, each axle 13, 16, or each axle 13, 14, 15 and 16, may be provided with its own drive motor.

In another embodiment (not explicitly shown here), the number of axles can be increased for the mission module 3. For example, either the drive module 2 and/or the mission module 3 may be provided with three axles or with four axles.

Also in accordance with the present invention, the mission module 3 may be provided with an energy supply comprising a plurality of energy lines 86 arranged from a battery 80 of the drive module 2 to the mission module 3. In the alternative, the mission module 3 comprises an energy supply 82, such as a battery or the like, disposed to supply energy solely to the mission module 3. In still another alternative, the mission module 3 is provided with the energy supply comprising a plurality of energy lines 86 arranged from the drive module 2 to the mission module 3 and the mission module comprises the second energy supply 82 disposed to supply energy solely to the mission module 3.

1. A vehicle divided into an anterior drive module and a posterior mission module, wherein the mission module is configured to accept a vehicle crew comprising at least one driver, and the mission module comprises one or more mission-specific expansions, and wherein the drive module comprises at least one drive motor and is unmanned, and the vehicle further comprises:
an articulated steering drive integrated between the drive module and the mission module so that the drive module is steered by the at least one driver in the mission module and so that the vehicle is thus moved by tracking the mission module behind the drive module.

2. A vehicle according to claim 1, wherein the articulated steering drive also drives the posterior mission module.

3. A vehicle according to claim 1, wherein the articulated steering unit is attached at an anterior housing part of the mission module and at a posterior housing part of the drive module.

4. A vehicle according to claim 1, wherein only the mission module has a high degree of armor protection comprising armor-plating that is arranged only around the mission module.

5. A vehicle according to claim 1, wherein the drive module has a low construction profile relative to the mission module so that the at least one driver operates the drive module by looking over and above the drive module.

6. A vehicle according to claim 1, wherein heat insulating means against an IR-signature of the drive module are arranged around the drive module.

7. A vehicle according to claim 1, wherein the mission module is equipped with an angle mirror/periscope on a roof of the mission module, wherein the at least one driver, or a Commander, or the at least one driver and the Commander, operate the articulated steering drive to steer the drive module while looking over the drive module with the angle mirror/periscope.

8. A vehicle according to claim 1, wherein a plurality of cameras are integrated in the vehicle for assisting the at least one driver steer the drive module, or the mission module, or both the drive module and the mission module.

9. A vehicle according to claim 1, wherein the mission module is provided with an energy supply comprising a plurality of energy lines arranged from the drive module to the mission module.

10. A vehicle according to claim 1, wherein the vehicle is an armored vehicle.

11. A vehicle according to claim 2, wherein the articulated steering unit is attached at an anterior housing part of the mission module and at a posterior housing part of the drive module.

12. A vehicle according to claim 2, wherein only the mission module has a high degree of armor protection comprising armor-plating that is arranged only around the mission module.

13. A vehicle according to claim 2, wherein the drive module has a low construction profile relative to the mission module so that the at least one driver operates the drive module by looking over and above the drive module.

14. A vehicle according to claim 3, wherein the drive module has a low construction profile relative to the mission module so that the at least one driver operates the drive module by looking over and above the drive module.

15. A vehicle according to claim 4, wherein the drive module has a low construction profile relative to the mission module so that the at least one driver operates the drive module by looking over and above the drive module.

16. A vehicle according to claim 11, wherein the drive module has a low construction profile relative to the mission module so that the at least one driver operates the drive module by looking over and above the drive module.

17. A vehicle according to claim 12, wherein the drive module has a low construction profile relative to the mission module so that the at least one driver operates the drive module by looking over and above the drive module.

18. A vehicle according to claim 1, wherein the mission module comprises an energy supply disposed to supply energy solely to the mission module.

19. A vehicle according to claim 1, wherein the mission module is provided with a first energy supply comprising a plurality of energy lines arranged from the drive module to the mission module and the mission module comprises a second energy supply disposed to supply energy solely to the mission module.
